(19) United States
(12) Patent Application Publication
(10) Pub. No.: US 2008/0298537 A1
(43) Pub. Date: Dec. 4, 2008

(54) PLANAR X-RAY TOMOSYNTHESIS DEVICE

(76) Inventor: Rohit Patnaik, Carlsbad, CA (US)

Correspondence Address: Rohit Patnaik, 3409 Corte Brezo, Carlsbad, CA, 92009, US

(21) Appl. No.: 12/013,453

(22) Filed: Jan. 13, 2008

Related U.S. Application Data
(60) Provisional application No. 60/941,677, filed on Jun. 3, 2007.

(51) Int. Cl. G01N 23/00

(52) U.S. Cl. 378/4

(57) ABSTRACT

The present invention is claimed as an apparatus and a method for acquiring multi-angle images for a region of interest. The apparatus includes a x-ray source producing a beam of radiation; a surface to support the region of interest that moves the region of interest to at least one location; and a x-ray detector that is moved to location in order to receive a portion of the beam that has passed through the region of interest, the x-ray detector producing from the received portion of the beam an image. In another embodiment a plurality of detectors are used instead and they can each receive a portion of the beam that has passed through the printed circuit board.

### FIELD OF THE INVENTION

The present invention relates generally to x-ray imaging systems and methods. This particular invention relates to x-ray tomosynthesis inspection techniques and systems.

### BACKGROUND OF THE INVENTION

Decreasing size of parts and increasing density of solder connections on populated printed circuit boards (PCB) have made the access to these solder connections very difficult. The past practice of visually inspecting PCB's has become extremely difficult and strenuous. Some form of automated analysis is required especially in high volume manufacturing cases. Electrical testing which was more of a norm in the past is now challenged as there is little or no room to place measurement probes. Many telecommunication boards which have RF shields on the board make both electrical and optical modes of inspection extremely difficult and inconvenient. There are various other modes of inspection available in the market place with potential advantages and disadvantages depending upon the problem being solved.

X-rays have become an important mode for verification of soldered connections not just because of the aforementioned problems but also because it is possible to verify the topside and bottom side of the board using the same acquisition as x-rays transmit through the object being verified and thus carry the signature of the connections themselves on both sides of the board. Using 3-D techniques it is possible to separate the topside information from the bottom side and conduct verification near simultaneously.

One important device class becoming popular is devices such as BGA devices or Ball Grid Array devices. These devices have an array of balls/bumps that make contact and upon heating fuse with the pads/solder on PCB's. The advantages of using such devices are that you can get a large number of connections per unit area and these devices are self aligning but the disadvantages are that these connections are not visible under standard light and thus other modes such as x-rays are used. But often the part itself occludes the defect signature that needs to be seen. In these cases 3-D techniques that reconstruct a digital slice representing a single plane passing through the object at a specific elevation are employed to “see” through the occlusion and create slices. These methods require imaging the portion to be seen using x-rays as the source using a beam that is incident to the object to be imaged at various angles. The generated slice is very useful in analyzing the qualities of the solder joint and then to make a decision regarding its validity.

In a typical configuration based upon a U.S. Pat. No. 4,688,241 issued to Richard S. Peugot, the tomosynthesis method utilizes a steerable x-ray tube, a large detector, an object positioned in a plane between the detector and the source, such that the electron beam passes through the center of the object and are collected at the detector and acquired through a complex arrangement of mirrors and motors. The main disadvantages are that this leads to a lot of moving parts that need to be synchronized very precisely, not to mention the large expensive detector and the expensive steerable tube.

In another configuration based upon a U.S. Pat. No. 6,748,046, issued to Dale Thayer, the method is greatly simplified and made cheaper in cases where a complete PCB board is to be analyzed. The method requires fixed tic-tac-toe image arrangement or a hexagonal image arrangement and also the entire field of view is not utilized for the view being analyzed. The angle of incidence which may be critical to “seeing” defects may be limited as well.

### SUMMARY OF THE INVENTION

Our proposal describes a method that is both inexpensive and efficient with respect to size of PCB. The use of a standard sealed tube enables us to use a method that is inexpensive and the system architecture makes it efficient in terms of angles achieved to have an effective inspection system. The compact detectors in market today are suitable for this kind of application as the detector can be moved around easily.

### BRIEF DESCRIPTION OF THE DRAWINGS

FIG. 1 Illustrates the method described with some of the multi-angle images being acquired by the movable detector. The table moves to one location in order to position the region of interest under the x-rays and the detector moves to one or more locations to acquire required portions of x-rays.

FIG. 2 shows the region of interest acquired at each detector position using a square path.

FIG. 3 shows the region of interest acquired at each detector position using an elliptical path.

FIG. 4 shows the acquisition path with a fixed source, a movable table but a stationary set of detectors.

FIG. 5 shows an example of multiple detectors that can receive portions of the x-ray beam simultaneously.

### DETAILED DESCRIPTION OF PREFERRED EMBODIMENTS OF THE INVENTION

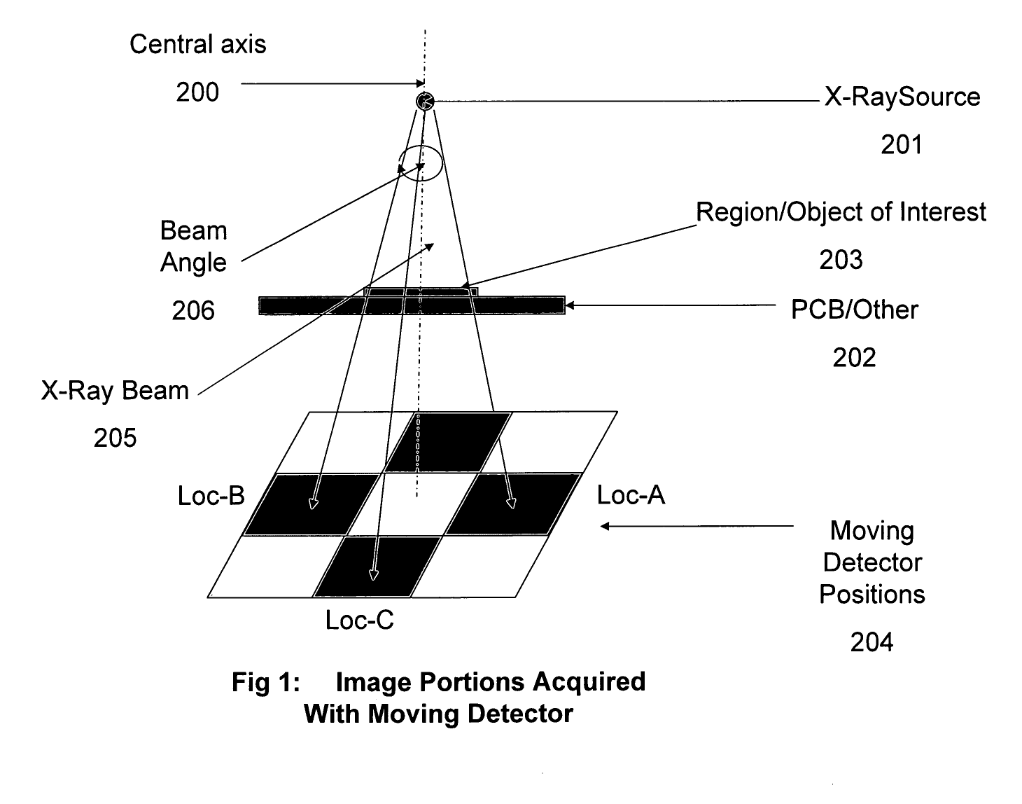

The presently preferred embodiments are described with reference to FIG. 1-3. FIG. 1 shows an x-ray source 201, a x-ray detector 204, an electronic PCB assembly 202 with an assembled part 203. Although the figure shows a PCB assembly 202 with assembled parts 203, this is applicable to any object or region of interest of an object 203 which may be for example a part of an object/objects and the PCB. The x-ray source 200 emits x-rays that are attenuated as they directly or obliquely pass through the assembled part or region of interest and the printed circuit board. The attenuated x-rays passing through the region of interest impinge on the coated scintillating material converts to visible light on the x-ray detector 204 which in turn is converted to an electrical charge signal that is read out as a digital image. FIG. 1 shows different positions of the detector while that the position of the printed circuit board 202 is at the same position in order to expose a region of the printed circuit board assembly 202 to the x-ray beam and a portion of the beam is collected in each detector position.

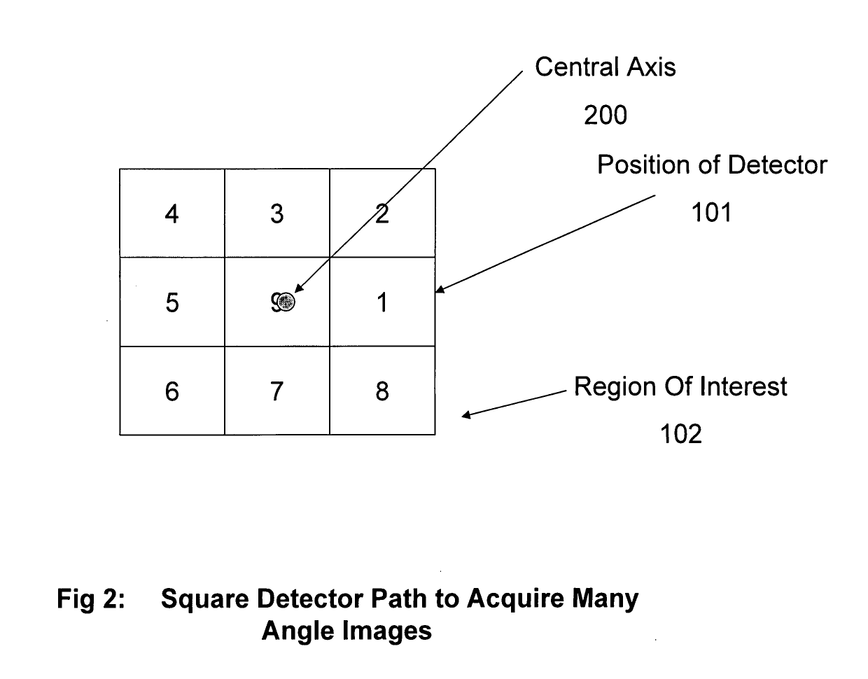

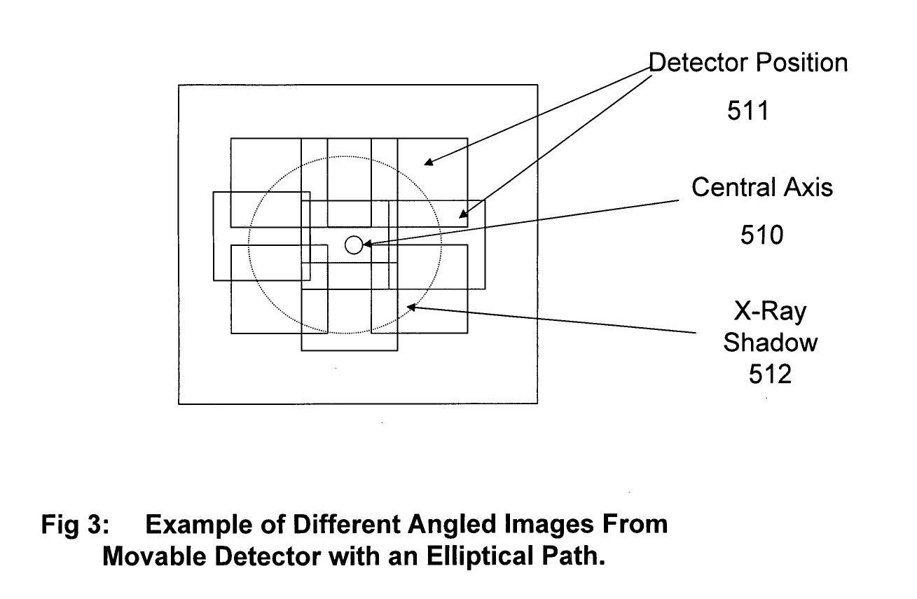

The x-ray source 201 is fixed in any configuration and the x-ray detector 204 is movable in any configuration but both may be movable on an independent vertical axis. The central axis 200 passes through the mid-point of the x-ray source and is perpendicular to the detector when the detector is at the center directly under the source. A horizontal x-y table may hold the printed circuit assembly 202 and move it around in that plane. The PCB assembly or the object or the object region of interest 203 moves relative to the x-ray source 201 and while the printed circuit assembly 202 is exposed to x-rays the x-ray detector 204 is then moved to individual positions but following a circular or other path as in FIG. 3 or a square path as in FIG. 2 to acquire all the portions of the x-ray beam 205. FIG. 2 shows a path that may be taken with each square representing the location where the detector 101 is positioned to collect the x-rays to convert to an electronic representation. All the locations 101 may not be needed. Several such image sequences as in FIG. 2 may be needed to satisfy the set of required images for tomosynthesis. Images at a minimum of two such positions are required so as to be combined together using standard tomosynthesis algorithms to create slices parallel to the x-y plane which is also the plane perpendicular to the central axis 200. However there is no limit to the number of images at different positions that can be combined using the tomosynthesis algorithm and more number of images are generally better. In practice however there are always limits on time and therefore one has to limit the number of acquisitions. The area of interest can be moved to different locations along a pre-determined path.

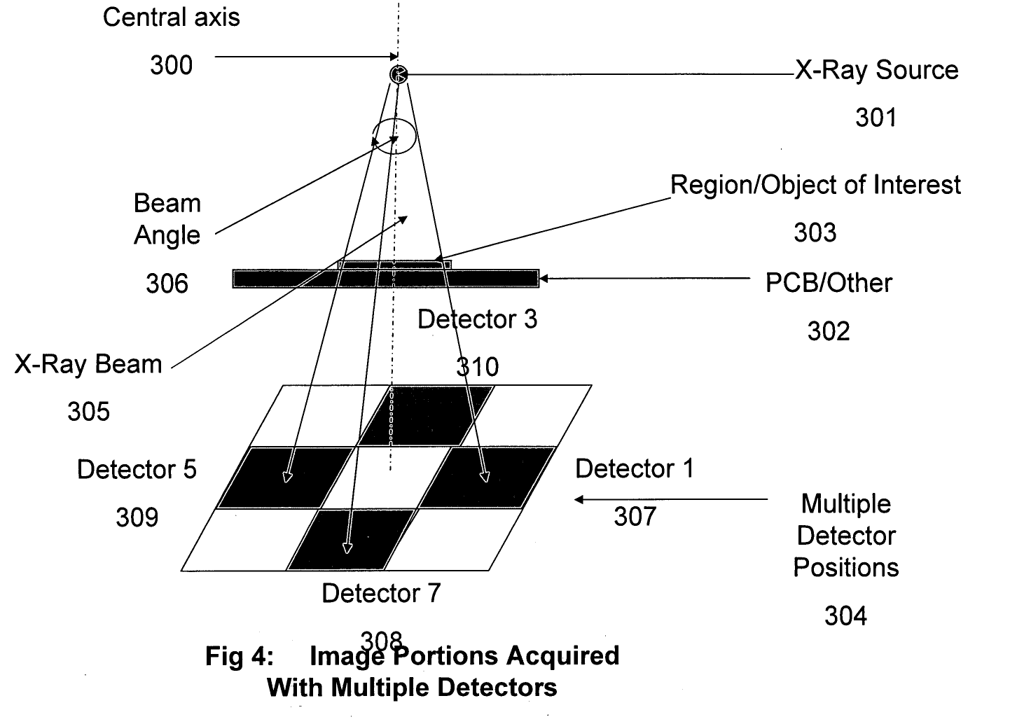

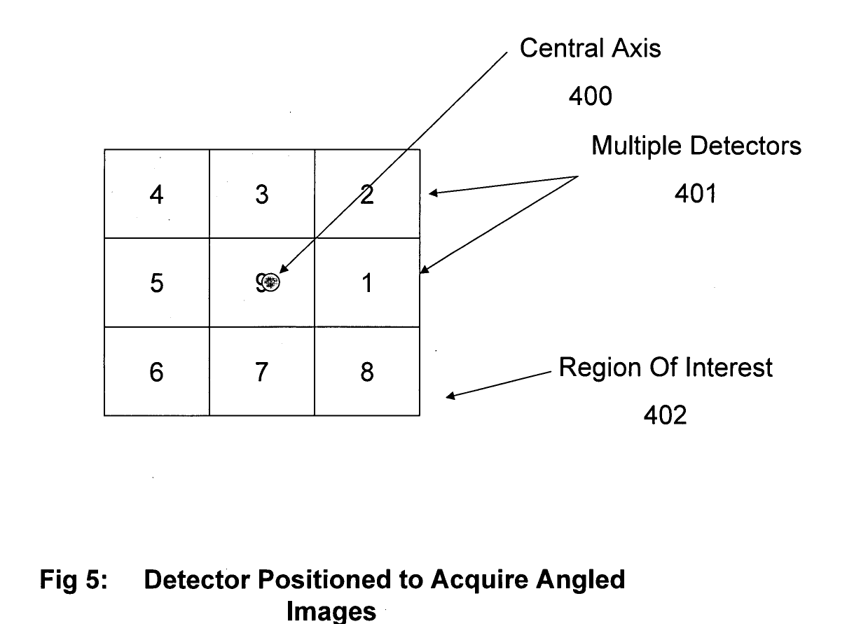

Another embodiment is described with reference to FIG. 4-5. FIG. 4 shows an x-ray source 301, a x-ray detector 304, an electronic PCB assembly 302 with an assembled part 303. Although the figure shows a PCB assembly 302 with assembled parts 303, this is applicable to any object or region of interest of an object 303 which may be for example a part of an object/objects and the PCB. The x-ray source 300 emits x-rays that are attenuated as they pass through the assembled part or region of interest and the printed circuit board. The attenuated x-rays passing through the region of interest impinge on the coated scintillating material converts to visible light on the x-ray detector 304 which in turn is converted to an electrical charge signal that is read out as a digital image. FIG. 4 shows a plurality of detectors for example 307-310 may be mounted at different locations while that the position of the movable surface that supports the printed circuit board 302 is at any one position in order to expose the region of the printed circuit board assembly 302 to the x-ray beam and portions of it read from different detectors that collect the x-rays.

The x-ray source 301 is fixed in any configuration and a plurality of X-ray detectors 304 receives portions of the x-ray beam simultaneously but both may be movable on an independent vertical axis. In one form the plurality of detector may even move to multiple locations in sequence with the plurality in each location receiving X-ray beam simultaneously. A minimum of two detectors are specified but more than two could be used. In the most common case almost all the detectors may be positioned to receive the x-rays passing through the PCB. It may be necessary to move the detector array to move to a plurality of locations to complete the capture of all the required images. A horizontal x-y table may support the printed circuit assembly 302 and move it around in that plane. The PCB assembly or the object or the object region of interest 303 moves relative to the x-ray source 301 and while the printed circuit assembly 302 is exposed to x-rays, the x-ray detector 304 is then moved following a circular or square or other path to receive all the required portions of the x-ray beam 305. Depending upon the number of detectors attached the images at a minimum of two such positions are required so as to be combined together using tomosynthesis algorithms to create slices parallel to the x-y plane which is also the plane perpendicular to the central axis. However there is no limit to the number of images at different positions that can be combined using the tomosynthesis algorithm and more number of images are generally better. In practice however there are always limits on time and therefore one has to limit the number of acquisitions. The area of interest can be moved to different locations along a pre-determined path.

What is claimed is:

1. An apparatus for acquiring X-ray images of a region of interest, comprising:
a source producing a beam of radiation; a surface to support the region of interest that moves the region of interest to at least one location; and a X-ray detector that moves to at least two locations to receive a portion of the beam that has passed through the region of interest, the X-ray detector producing from each received portion of the beam an image.

2. The apparatus of claim 1 wherein the electronic representations of a region of interest are transferred from the detector to a processor for processing into images of the region of interest.

3. The apparatus of claim 1 further comprising a processor to combine at least two digital representations of the region of interest to produce a tomosynthetic image.

4. The apparatus of claim 1 wherein the X-ray detector may be movable to position the detector to receive a portion of the beam and continue this process at multiple locations.

5. The apparatus of claim 1 wherein the support surface may be moveable to position the regions of interest within the beam.

6. An apparatus for acquiring X-ray images of a region of interest, comprising:
a source producing a beam of radiation; a surface to support the region of interest that moves the region of interest to at least one location; and a plurality of X-ray detectors receive portions of the beam that has passed through the region of interest, the X-ray detectors producing from each received portion of the beam an image.

7. The apparatus of claim 6 wherein the electronic representations of a region of interest are transferred from the detector or detectors to a processor for processing into images of the region of interest.

8. The apparatus of claim 6 further comprising a processor to combine at least two digital representations of the region of interest to produce a tomosynthetic image.

9. The apparatus of claim 6 wherein the plurality of X-ray detectors either stationary or movable or a combination may be movable to position the detectors to receive portions of the beam.

10. The apparatus of claim 6 wherein the support surface may be moveable to position the regions of interest within the beam.
